(19) United States
(12) Patent Application Publication
(10) Pub. No.: US 2009/0095439 A1
(43) Pub. Date: Apr. 16, 2009

(54) BOROSILICATE GLASS-CONTAINING MOLDING MATERIAL MIXTURES

(75) Inventors: Reinhard Stotzel, Borken (DE); Diether Koch, Mettmann (DE); Antoni Gieniec, Hilden (DE); Jens Muller, Haan (DE); Gunter Weicker, Solingen (DE); Hans-Jurgen Werner, Essen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: ASHLAND-SUDCHEMIE-KERNFEST GMBH, Hilden (DE)

(21) Appl. No.: 12/065,522

(22) PCT Filed: Sep. 1, 2006
(86) PCT No.: PCT/EP2006/008571

§ 371 Date: Jul. 25, 2008

(30) Foreign Application Priority Data
Sep. 2, 2005 (DE) 10 2005 041 863.5

(51) Int. Cl. B22C 9/00; B22D 23/00; C08K 3/40; C08L 75/04; C08L 67/00; C08L 71/10; C08L 83/02; C08K 3/22

(52) U.S. Cl. 164/520; 164/349; 164/47; 524/494; 524/590; 524/599; 524/611; 524/588; 524/431; 524/449

(57) ABSTRACT

The invention relates to a molding composition for producing casting molds for the foundry industry, comprising at least:
a refractory mold material;
a binder for curing the molding composition;
a proportion of a borosilicate glass.

The invention further relates to a process for producing a molding from the molding composition of the invention, the corresponding casting mold or the corresponding molding and also their use in metal casting.

The invention relates to a molding composition for producing moldings for the foundry industry, a process for producing such moldings for the foundry industry, moldings for the foundry industry and the use of such moldings for the foundry industry in a process for casting a casting.

In the production of metal castings, a model whose shape corresponds essentially to that of the metal casting to be produced is firstly produced. This model is provided with sprues and feeders. To produce a casting mold, the model is surrounded by a mold mix in a mold box. The mold mix consists essentially of a refractory solid, for example silica sand, and a binder by means of which the grains of the solid are bound on curing to form a solid molding. The mold mix is compacted and then cured. To cure the molding, it can, for example, be heated to evaporate solvent present in the binder or to initiate a crosslinking reaction in the binder. However, it is also possible to add a catalyst, either during preparation of the mold mix or by passing a gaseous catalyst through the compacted molding. After curing, the molding is taken from the mold box or the model.

Casting molds are composed of molds and cores. The molds define the outer contour of the casting. The internal contour of the casting or the boundary of a hollow space located in the casting is formed by cores. In the finished casting mold, a shaped hollow space is formed between mold and core and this is filled with liquid metal during casting.

Apart from cores and molds, there are also hollow bodies known as feeders which act as equilibration reservoir. During casting, these firstly accommodate liquid metal and it is ensured by appropriate measures that the metal in these remains liquid longer than the metal located in the hollow space of the mold. When the metal in the hollow space of the mold solidifies, further liquid metal can flow in from the equilibration reservoir to compensate for the volume contraction occurring on solidification of the metal.

After the casting mold has, if appropriate, been assembled from a plurality of moldings, liquid metal is introduced into the hollow space of the casting mold. The inflowing liquid metal displaces air present in the hollow space of the mold. The air escapes through openings provided in the casting mold or through porous sections of the casting mold, for example through the wall of a feeder. After the metal casting has solidified, it is taken from the casting mold. For this purpose, the casting mold can, for example, be vibrated or shaken so that it once again disintegrates into grains. The casting is freed of the internal cores by further shaking.

The surface of the metal castings frequently has defects, so that further machining is necessary to achieve the desired nature of the surface. These defects are due to the heat to which the casting mold is subjected during casting of the molten metal and which produces stresses in the material of the casting mold. This leads to formation of cracks on the surface of the mold or the cores. The molten metal penetrates these cracks and thus leaves laminar structures, generally also known as flash, in the casting. These casting defects occur particularly when using silica sand as mold material, since the silica sand experiences a change in its crystal structure and thus, for example, also its density under the action of the heat from the liquid metal. In addition, further casting defects such as scabs, penetration and burning-in can also occur.

To achieve substantial suppression of casting defects, various additives intended to compensate for the change in volume of the mold material are added in addition to silica sand to the mold mix.

For example, iron oxide is added in amounts of from about 1 to 3% by weight to the silica sand. The silica and the iron oxide can form fayalite, as a result of which the stresses occurring in the casting mold are reduced and the tendency to form flash is therefore reduced. However, a disadvantage is the lower mechanical strength of the casting mold which is observed when iron oxide is added. In addition, the formation of fayalite leads to an increased risk of penetration of the metal into the casting mold, which produces unevennesses on the castings which then have to be subjected to further machining. In addition, organic material such as wood flour or carbon dust can be added to the mold mix in amounts of from about 1 to 3% by weight to reduce flash formation. The organic material burns away during the casting process and forms hollow spaces which accommodate the volume growth of the silica sand over the entire volume of the casting mold, so that there is no external change in size of the casting mold. A disadvantage of these additives is the amount of gas formed during combustion. If the gas cannot escape from the casting mold, bubbles are formed in the liquid metal as a result of the intruding gas and these form voids in the solidified casting. Furthermore, addition of the above-described organic additives reduces the stability of the casting mold, so that this is less able to withstand mechanical stresses occurring during the casting process.

Furthermore, the formation of flash can also be suppressed by the addition of from 0.5 to 5% by weight of titanium oxide to the mold sand, as described, for example, in U.S. Pat. No. 4,735,973. The titanium oxide reduces the thermal expansion of the mold material and thus largely prevents the formation of flash. Titanium dioxide also does not adversely affect the mechanical strength of the casting mold and when used as additive also does not result in formation of additional gases. However, mold mixes containing titanium oxide as additive display an increased tendency of the liquid metal to penetrate into the wall regions of the casting mold, so that the surface of the casting mold has to be treated with a wash or other materials before casting.

A further possible way of improving the quality of the casting is to use mold materials having a reduced thermal expansion, for example chromite sand, zircon sand or olivine sand. Casting molds made of these mold materials result in reduced formation of flash. However, these mold materials are relative expensive.

Finally, the sand can also be treated so that is firstly melted to a type of paste in the furnace and is milled after solidification. The sand obtained is mixed with about 50% of silica sand. The mold material obtained in this way no longer expands during casting, so that virtually no formation of flash is observed. Disadvantages of this method are the complicated procedure for producing the mold material and the high costs associated therewith.

EP 0 891 954 A1 describes mold mixes which contain a proportion of hollow aluminum silicate microspheres. The addition of hollow aluminum silicate microspheres enables the formation of cracks on the surface of the casting mold to be substantially suppressed. The thermal expansion of the mold material is compensated by the hollow spaces in the spheres. The additive neither reduces the mechanical strength of the casting molds nor leads to increased gas formation. However, to be able to obtain an optimal result in casting, the proportion of hollow spheres has to be in the range of about 10-20% based on the total mold mix. This once again increases the costs for producing the casting mold.

DE 196 09 539 proposes adding cryolite as additive to mold mixes for the foundry industry. A flash-free surface can be achieved by addition of 0.1-10% by weight of cryolite, based on the sand. Cryolite can be used as sole additive or in combination with other components such as wood flours, mica, iron oxide, etc. However, the use of cryolite results in other casting defects which make themselves apparent, inter alia, in extreme pebbling of the surface of the casting.

A further technique which is used in foundries for improving the surface of castings is the coating of casting molds with suspensions of (highly) refractory inorganic materials. This mold coating, generally referred to as a wash, is intended to protect the casting mold against the thermal stress caused by the molten metal so as to lead to an improvement in the surface of the casting, make clean separation of liquid metal and casting mold possible and reduce surface defects on the casting.

Washes consist in the simplest case of a carrier liquid in which a finely divided refractory material is suspended. The wash can be applied by, for example, painting, spraying, casting or dipping to at least the surfaces of the casting mold which come into contact with the liquid metal. Binders present in the carrier liquid serve to fix the inorganic base materials to the surface of the casting mold after drying.

Typical inorganic base materials which are used in washes are mineral oxides such as α-alumina, magnesite, mullite, silica or chromite, silicates such as zirconium silicate, olivine or chamotte and also coke or graphite. As carrier liquid, it is possible to use water or organic solvents such as ethanol or isopropanol. Typical binders are starch derivatives, lignin derivatives, natural resins, synthetic resins or plastics. Washes often also contain suspending agents which prevent settling of the solid constituents in the carrier liquid. Suspending agents used are swellable sheet silicates or cellulose derivatives which are capable of incorporating water.

A frequently encountered disadvantage of washes is the very dense structure of the mold coatings, so that satisfactory gas permeability cannot be ensured. However, it is necessary for gases formed by thermal decomposition of the binder during the casting process to be able to be removed in a controlled fashion. Otherwise, the gas pressure in the interior of the cores can exceed the metallostatic counterpressure and lead to boiling of the metal and thus to gas bubble inclusions in the casting. Partial spalling of the coating and subsequent trapping of the fragment in the casting can also be observed.

DE-C 42 03 904 proposes introducing organic fibers into the wash to increase the gas permeability. However, the fibers tend to form clogs, so that neither a uniform distribution nor a smooth application of the wash can be ensured.

WO 94/26440 describes a foundry wash for producing mold coatings which has a content of inorganic hollow spheres of 1-40% by weight, based on the ready-to-use wash. The wash can additionally have a content of inorganic or organic fibers of 0.1-10% by weight, based on the ready-to-use wash. The hollow spheres are preferably filled with an inert gas. They can comprise oxides such as aluminum oxide, silica, magnesite, mullite, chromite, zirconium oxide and/or titanium oxide, borides, carbides and nitrides, e.g. silicon carbide, titanium carbide, titanium boride, boron nitride and/or boron carbide, carbon, glass or metals or mixtures of these materials. In the examples, hollow spheres of aluminum silicate of which 80% have a particle size in the range 250-90 μm are used. They are present in a proportion of 5 or 10% by weight in the case of aqueous washes, and 4 or 10% by weight in the case of alcohol-based washes. Hollow spheres of other materials are not used in the examples. No details are given about the properties and the composition of hollow spheres of glass.

Furthermore, mold mixes and washes are subsumed under the term “molding composition”. A “mold mix” is a mixture which is used for producing casting molds or moldings by shaping and curing.

It was an object of the invention to provide a molding composition for producing casting molds for the foundry industry, which makes it possible to produce casting molds which result in a smooth surface which is largely free of casting defects on the casting.

This object is achieved by a molding composition for producing casting molds for the foundry industry which has the features of claim 1. Advantageous embodiments of the molding composition are subject matter of the dependent claims.

The molding composition of the invention contains a borosilicate glass as essential constituent. It has surprisingly been found that the addition of borosilicate glass enables a significant improvement in the surface of castings to be achieved, i.e. the number and intensity of casting defects can be significantly reduced. Flash formation and the tendency for penetration to occur can be virtually eliminated by the proportion of borosilicate glass in the molding composition. A further advantage of the addition of borosilicate glass to the molding composition is the particularly smooth surface of the casting obtained when casting is carried out. The moldings or casting molds produced from the molding composition of the invention have a high mechanical strength, so that the risk of breakage of the molding or the casting mold during removal from the molding tool or erosion of the casting mold on filling with the liquid metal can be significantly reduced compared to the casting molds known hitherto.

The molding composition of the invention can be either in the form of a mold mix for producing casting molds ore in the form of a wash. Apart from the borosilicate glass, the molding composition of the invention contains a mold material and a binder by means of which the mold material can be cured. Preference is given to using a refractory mold material as mold material.

As refractory mold material, it is possible to use, for example, aluminum silicate, for example fibrous refractory materials, or else silica sand, zirconium oxide or chrome ore sand. It is also possible to use synthetic refractory mold materials, for example mullite (x Al₂O₃·y SiO₂, where x=2 to 3 and y=1 to 2; ideal formula: Al₂SiO₅). It is also possible to use reprocessed foundry sand as mold material.

In an embodiment of the molding composition of the invention as wash, the inorganic mold materials customary for washes can be used as mold material. Suitable mold materials are, for example, mineral oxides such as α-alumina, magnesite, mullite, silica or chromite, silicates such as zirconium silicate, olivine or chamotte and also coke or graphite.

The choice of mold materials is not subject to any restrictions per se. It is possible to use all mold materials customary for mold mixes or washes.

As further constituent, the moldinq composition of the invention contains a binder for curing the molding composition. Here too, binders customary in the field of foundry technology are employed. If the molding composition of the invention is in the form of a mold mix for producing moldings or casting molds, it is possible to use binders as are used, for example, in the cold box, hot box or warm box process. It is also possible to use, for example, water glass as binder. Preference is given to using organic binders. if water glass is used as binder, the molding composition of the invention does not, in one embodiment, in particular in an embodiment as mold mix for producing moldings or casting molds, contain a particulate metal oxide, in particular a particulate metal oxide selected from among the group consisting of silicon dioxide, aluminum oxide, titanium oxide and zinc oxide. If the molding composition of the invention is in the form of a wash, it is possible to use, for example, starch derivatives, lignin derivatives, natural resins, synthetic resins or plastics as binder.

The proportion of mold material or of binder is chosen within customary ranges. In one embodiment as mold mix for producing moldings or casting molds, the mold material is usually present in a proportion of 50-99.7% by weight, preferably from 80 to 99.5% by weight, and the binder is present in a proportion of from 0.3 to 20% by weight, preferably from 0.5 to 10% by weight, in each case based on the weight of the molding composition. In an embodiment of the molding composition of the invention as wash, the mold material is present in a proportion of from 50 to 98% by weight, preferably from 60 to 90% by weight, and the binder is present in a proportion of from 2 to 10% by weight, preferably from 3 to 5% by weight, in each case based on the solids in the wash, i.e. without solvent.

Apart from the constituents mentioned, the molding composition of the invention can contain further customary constituents, for example clay minerals, graphite, dextrins, mineral oils, etc.

The advantageous properties of the molding composition of the invention can be observed even at very small proportions of borosilicate glass. The borosilicate glass is preferably present in the molding composition in a proportion of at least 0.001% by weight, more preferably at least 0.005% by weight, in particular at least 0.01% by weight, based on the mold material or in the case of a wash based on the solids. The proportion of borosilicate glass is preferably less than 5% by weight, particularly preferably less than 2% by weight and very particularly preferably in the range from 0.01 to 1% by weight, in each case based on the mold material or in the case of a wash on the solids.

The borosilicate glass can be present in the form of granules or a powder in the molding composition of the invention. The particle diameter of the granules and powder is preferably selected so that the average diameter D₅₀ is in the range 5-500 μm, particularly preferably 10-250 μm. The average diameter D₅₀ can be determined by conventional methods, for example by sieve analysis or laser granulometry. The fineness of the granules or powder is particularly preferably selected so that the amount retained on a sieve having a mesh opening of 350 μm is not more than 10% by weight and the amount retained on a sieve having a mesh opening of 200 μm is not more than 20% by weight.

In a particularly preferred embodiment, the borosilicate glass is present in the form of hollow microspheres in the molding composition. For the present purposes, hollow microspheres are hollow spheres which have a diameter in the range of preferably 5-500 μm, particularly preferably 10-250 μm, and whose shell is made up of borosilicate glass. The hollow microspheres are preferably filled with hydrogen, air or an inert gas, for example nitrogen or a mixture of nitrogen and carbon dioxide.

The hollow microspheres preferably have a diameter below 200 μm. The size of the hollow microspheres can be determined, for example, by sieve analysis.

The hollow microspheres preferably have a wall thickness of 5-30%, in particular 6-20%, of their external diameter.

The hollow microspheres preferably have a bulk density of less than 1.2 g/ml, particularly preferably less than 0.5 g/ml.

The hollow microspheres present in the molding composition of the invention can be made up of conventional borosilicate glass. The borosilicate glass preferably contains from 2 to 10% by weight of sodium oxide and potassium oxide, from 1 to 10% by weight of aluminum oxide, from 0 to 10% by weight of alkaline earth metal oxides and from 60 to 90% by weight of silicon dioxide. The borosilicate glass preferably has a boron content, calculated as B₂O₃, of more than 3% by weight, particularly preferably from 5 to 15% by weight. Further constituents can be organic silanes or siloxanes, for example methyltrimethoxysilane or dimethylpolysiloxane.

The inventors assume that the borosilicate glass, especially if it is present in the form of hollow microspheres in the molding composition, melts under the action of the heat from the liquid metal and as a result makes available hollow spaces which can compensate the volume increase of the mold material caused by the temperature increase.

The softening point of the borosilicate glass is preferably set within the range below 1500° C., particularly preferably in the range from 500 to 1000° C.

As indicated above, the molding composition of the invention can be in the form of a mold mix for producing moldings or casting molds, in particular molds and cores. To harden the molding composition, the molding composition contains a binder customary for the hardening of molding compositions. The binder is preferably selected from among cold box binders, hot box binders, self-curing binders and water glass (silicate binders).

The tendency for flash to be formed is particularly pronounced in the case of cold box binders. The use of hollow borosilicate glass microspheres is therefore particularly preferred in molding compositions which contain a cold box binder.

The cold box binder is preferably selected from the group consisting of phenol-urethane resins which can be cured by means of amines, epoxy-acrylic resins which can be cured by means of SO₂, alkaline phenol resins which can be cured by means of CO₂ or by means of methyl formate. In addition, it is also possible to use water glass, which can be cured, inter alia, by means of CO₂, or self-curing resins as binder.

Particular preference is given to using phenol-urethane resins which can be cured by means of amines as binder. These binders are known per se to those skilled in the art. Such binder systems are described, for example, in U.S. Pat. No. 3,409,579 or U.S. Pat. No. 4,526,219.

In a further preferred embodiment, water glass is used as binder. As water glass, it is possible to use conventional water glasses which have hitherto been used as binders in mold mixes for the foundry industry. These water glasses contain dissolved sodium or potassium silicates and can be produced by dissolving vitreous potassium and sodium silicates in water. The water glass preferably has an SiO₂/M₂O ratio in the range from 2.0 to 3.5, where M is sodium and/or potassium. The water glasses preferably have a solids content in the range from 20 to 50% by weight. It is also possible for solid water glass to be present in the molding composition of the invention. The proportions in the molding composition are in each case based only on the solids of the water glass. If water glass is used as binder, it can also be cured, for example, by dehydration.

A particular advantage of the addition according to the invention of borosilicate glass, in particular in the form of hollow borosilicate glass microspheres, to a molding composition is that the properties of other additives are not adversely affected by the addition according to the invention of borosilicate glass. Apart from the borosilicate glass, the molding composition of the invention therefore comprises, in a preferred embodiment, at least one further additive for reducing flash formation.

The at least one further additive is preferably selected from among combustible organic compounds, mica and iron oxide.

In a further preferred embodiment, the molding composition of the invention comprises an addition of at least one organic and/or inorganic acid and/or an acid source.

The processing time of a molding composition frequently depends on its pH. Thus, for example, bases can accelerate the curing process of the molding composition, especially in the cold box process. Since the addition of hollow microspheres to molding compositions can alter the pH, it is possible to counter this pH change and the shortening of the processing time of the molding composition which may be associated therewith by addition of suitable substances. This can be achieved, for example, by addition of organic or inorganic acids, but the addition of generally customary buffers is also possible. Examples of such acids are, inter alia, formic acid, acetic acid, maleic acid, malonic acid, fumaric acid, adipic acid, benzoic acid, various fatty acids such as oleic acid, lauric acid or stearic acid, lactic acid, citric acid, oxalic acid, boric acid, phenolsulfonic acid, para-toluenesulfonic acid, salicylic acid, glycolic acid, glyoxylic acid, phosphoric acid, sulfuric acid, hydrochloric acid, hydrofluoric acid or substances which act as sources of the abovementioned acids, for example phosphorus oxychloride. In the production of the molding composition, these acids can be added as such to the molding composition or be added as a mixture with the mold material and/or the binder or else as a mixture with further additives.

In a further preferred embodiment, the molding composition of the invention is in the form of a wash. The wash can be in the form of an aqueous wash or, for example, in the form of an alcohol-based wash. The washes of the invention are essentially the same as previously known washes but with hollow borosilicate glass microspheres being additionally present in the wash. The proportion of water or of alcohol is preferably from about 20 to 80% by weight, particularly preferably 40-70% by weight. The washes of the invention contain customary constituents such as bentonites for adjusting the flow properties, fibers, graphite, wetting agents or preservatives. When the washes of the invention are used, spalling of the protective coating due to the effects of the liquid metal is observed only in extremely rare cases, if at all.

The molding composition of the invention can contain not only the hollow borosilicate microspheres but also hollow microspheres of other materials, for example aluminum silicates. However, the molding composition of the invention preferably contains only hollow borosilicate glass microspheres and no microspheres composed of other materials.

The invention further provides a process for producing a molding for the foundry industry, wherein

a model which corresponds to at least a section of a casting is provided;

a mold mix is introduced into the model;

the mold mix is cured to form a molding; and

the molding is taken from the model.

The process of the invention is characterized in that at least surfaces of the molding which come into contact with the liquid metal during metal casting are formed from a molding composition of the type described above.

A molding for the foundry industry is generally a molding of the type used for forming a casting in a metal casting. Such moldings are, for example, molds and cores and also hollow bodies such as feeders or sprues. For the purposes of the present invention, casting molds are molds which are used directly for metal casting. Such casting molds can be made up of a plurality of moldings.

It is an important feature of the process of the invention that the production of the molding is carried out in such a way that at least the surfaces which come into contact with the liquid metal during casting have a proportion of borosilicate glass, in particular hollow borosilicate glass microspheres.

This can be achieved in various ways. In a first embodiment of the process, the mold mix for producing the molding consists entirely of a molding composition which is of the type described above and has a proportion of borosilicate glass. As indicated above, the borosilicate glass is preferably introduced in the form of hollow microspheres into the molding composition. In the production of the molding composition, the hollow borosilicate glass microspheres can be added as such to the molding composition or can be added as a mixture with the mold material and/or the binder or else as a mixture with other additives. Because of the relatively low mechanical strength of the hollow microspheres, no high shear forces should act on the molding composition during production of the molding composition so as to avoid premature destruction of the hollow microspheres.

The molding composition can be introduced into the model so that only parts of the model are filled with the molding composition containing borosilicate glass while the remaining volume is filled with a mold mix which is free of borosilicate glass. However, preference is given to the entire molding being produced from a molding composition containing borosilicate glass, in particular in the form of hollow microspheres. In this embodiment, a molding in which borosilicate glass, for example in the form of hollow microspheres, is distributed homogeneously throughout the entire volume is obtained.

The model for producing the molding corresponds to a model as has been described above in the introductory part; here, the model may also encompass the mold box.

In a further embodiment of the process of the invention, the above-described molding composition is applied in the form of a wash as mold coating. The molding for the foundry industry can be produced from a mold mix which likewise contains hollow borosilicate glass microspheres or is free of hollow borosilicate glass microspheres. The wash is applied to the cured or uncured molding by conventional methods, for example by spraying, painting or by dipping the casting mold into the wash.

The invention further provides a molding for the foundry industry made up from a refractory mold material, characterized in that borosilicate glass is present at least in sections of the molding which come into contact with liquid metal during a casting process. It has already been mentioned in the case of the process of the invention that the borosilicate glass has to be present only in outer sections of the casting mold or the molding, for example in the form of a mold material coating produced from a wash, or can be homogeneously distributed over the entire molding or the entire casting mold.

As mentioned above, the borosilicate glass is preferably present in the form of hollow borosilicate glass microspheres in the molding or in the mold coating produced from a wash. Further details regarding the properties of the hollow microspheres have been given above.

The invention additionally provides for the use of a casting mold for the foundry industry, which is of the type described above and may be made up of a plurality of moldings, in a process for casting a casting. The process is carried out in the usual way. A casting mold in which at least the surfaces which come into contact with the liquid metal are formed from a molding composition containing borosilicate glass, in particular in the form of hollow microspheres, is firstly produced. The liquid metal is then poured into this casting mold. As metals, it is in principle possible to use all metals which are customary for metal casting. Metals used can be light metals such as aluminum or magnesium, which have a relatively low melting point, or metals having a higher melting point, e.g. cast iron or steel. The use of hollow microspheres in casting molds or washes is not restricted to a particular type of casting but encompasses all types of casting ranging from light metal casting to steel casting. The casting mold according to the invention or the molding according to the invention for the foundry industry is particularly preferably used for casting of iron, since higher temperatures than in light metal casting are reached here.

The invention is illustrated below with the aid of examples and with reference to the accompanying figures. In the figures:

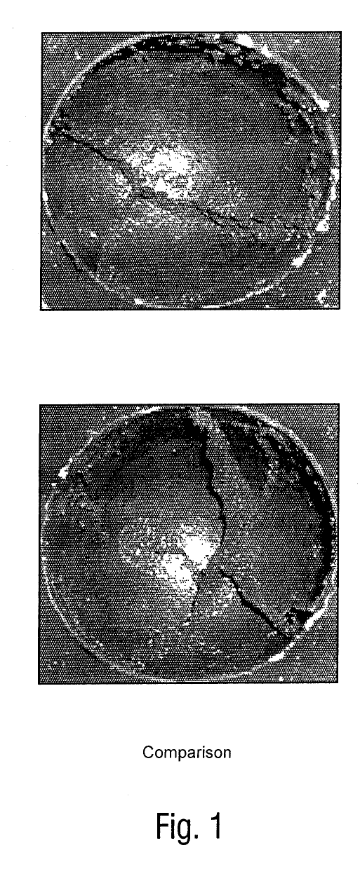

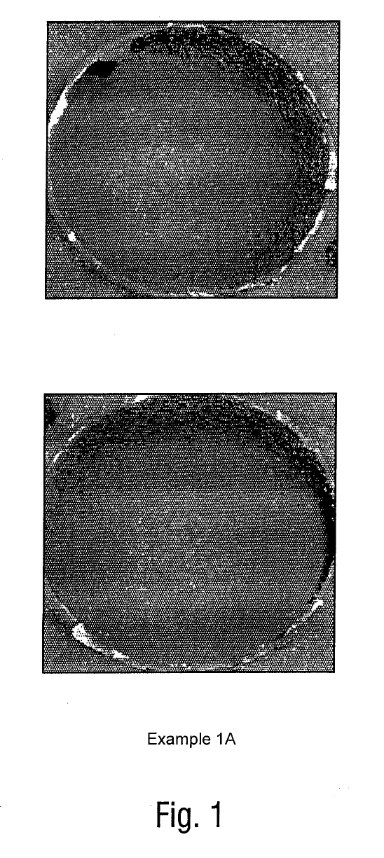

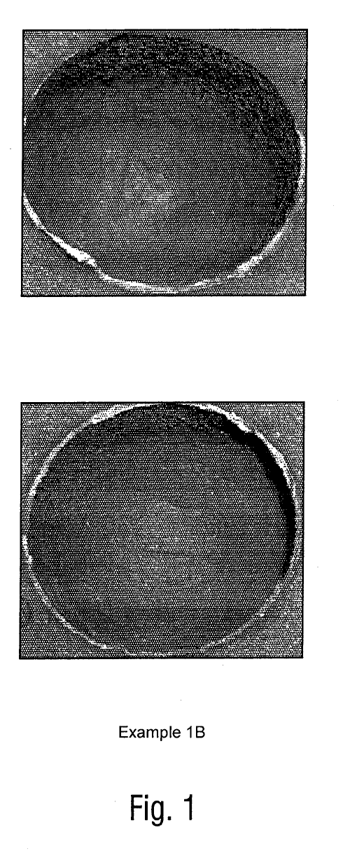

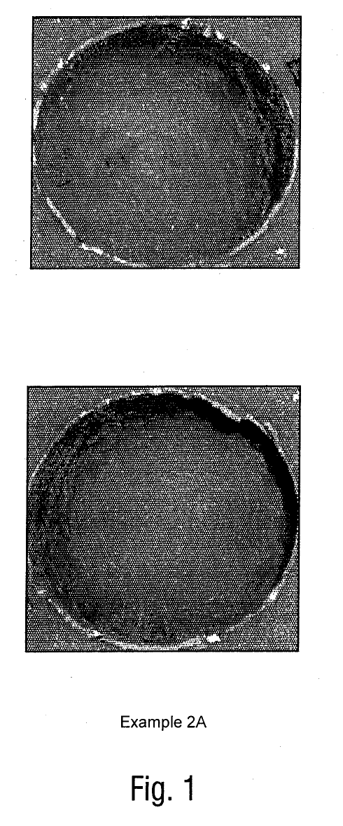

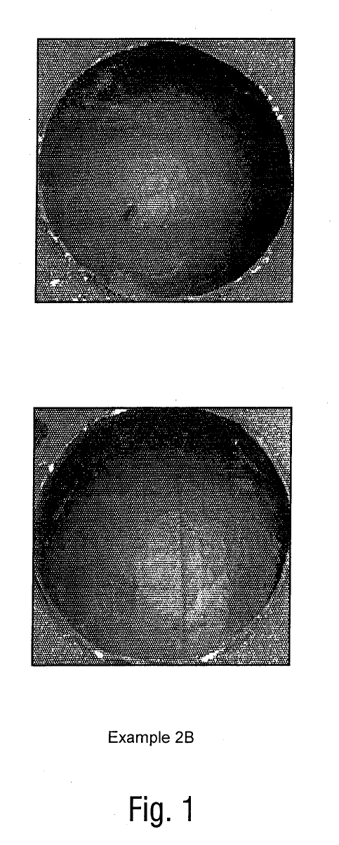

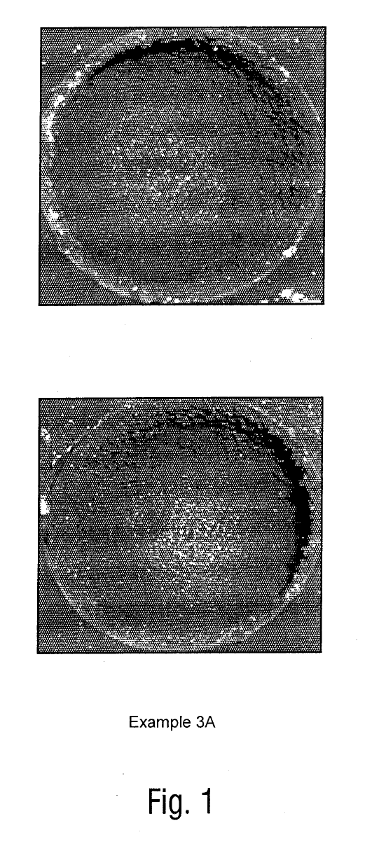

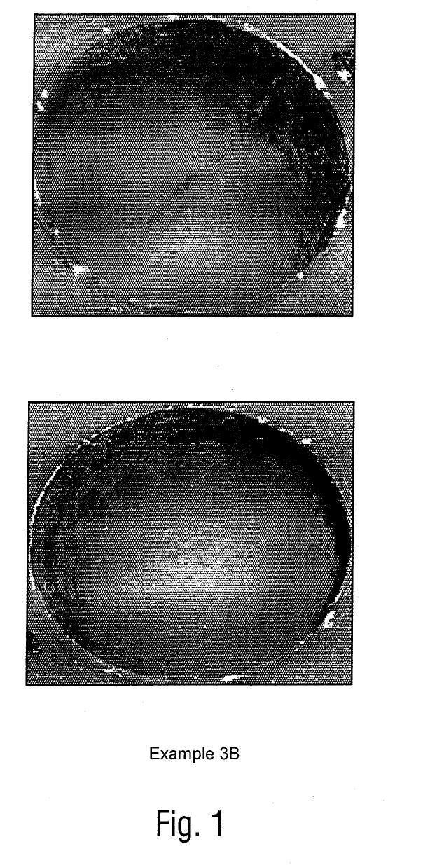

FIG. 1 shows a photographic reproduction of the surface of test specimens (dome cores) which had been obtained in the casting of iron using an uncoated molding containing additives which had partly been supplemented by hollow borosilicate glass microspheres;

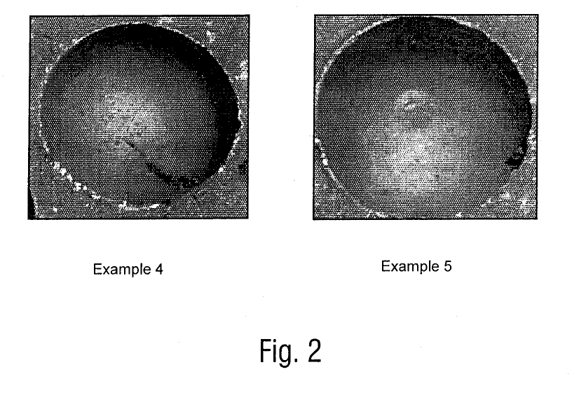

FIG. 2 shows a photographic reproduction of the surface of test specimens (dome cores) which had been obtained in the casting of iron using a coated molding. The mold coating in one case contained no hollow borosilicate glass microspheres and in the other case contained hollow borosilicate glass microspheres.

### Analytical Methods

### Determination of the Bulk Density:

A graduated glass cylinder cut off at the 1000 ml mark is weighed empty. The substance to be measured is subsequently introduced all at once by means of a powder funnel, so that a cone of material is formed above the upper edge of the measuring cylinder. The cone of material is struck off by means of a ruler and material adhering to outside of the cylinder is removed. The cylinder is weighed again. The weight difference corresponds to the bulk density.

Average Particle Diameter (d₅₀):

The average particle diameter by means of laser light scattering on a Mastersizer S, from Malvern Instruments GmbH, Herrenberg, Germany according to the manufacturer's instructions.

Hollow borosilicate glass microspheres Q-Cel type 5020FPS from OMEGA Minerals Germany GmbH were used for the following experiments. The microspheres have a white color, a particle size in the range 100-200 μm, an effective density of 0.14-0.70 g/cm³, a coefficient of thermal expansion of 9×10⁻⁶/°C. and a hardness (Mohs) of from 3.5 to 4.0. The average particle size of the hollow microspheres is 40 μm. The compressive strength is 4 MPa.

To assess the molding compositions, a dome core casting is produced in each case. For this purpose, a circular main core having a lid core and sprue core which enclose a cylindrical hollow space having a diameter of 310 mm and a height of 157 mm is produced from a molding composition comprising 20 kg of silica sand 100 T H25 and 160 g of Novathen® 155 and 160 g of Novathen® 260 (ASK GmbH, Hilden, Germany) as binder. 5 cupola-shaped dome cores having a height of 50 mm and a diameter of 50 mm are fixed by means of an adhesive at the bottom of the cylindrical hollow space. The dome cores are in each case produced from the molding composition to be examined. The mold is assembled by firstly adhesively bonding the dome cores to the bottom of the hollow space of the main core and closing the hollow space by means of the lid core. A circular opening having a diameter of 20 mm is provided in the lid core. The funnel-shaped sprue core is then affixed to the lid core in such a way that the funnel leads to the metal introduction opening of the lid core. Casting is carried out by means of gravity casting. The casting temperature is about 1410-1430° C. The casting time is about 10 seconds and the weight of the casting is about 15 kg.

### EXAMPLES 1 TO 3 AND COMPARATIVE EXAMPLE 1

### Use of Hollow Borosilicate Glass Microspheres in Mold Sands

For the trial, silica sand (Quarzwerke GmbH, Frechen), type H 32, was firstly admixed with the additives to be tested and then with a cold box binder (Isocure® 366 (part I) and Isocure® 666 (part II) from Ashland-Südchemie-Kernfest GmbH (ASK). The mixing time per component was one minute. The added amounts of the additive were 0-2.0% based on the total weight of the sand. The binder system was added in a proportion of 0.8-0.9% per part. The curing process was carried out by means of contact with amine gas. For this purpose, the catalyst 700 from ASK was passed at a flushing pressure of 2 bar through the core box.

For comparative example 1, a mixture without additive was produced. For examples 1 to 3, additives based on starch (example 1), mica (example 2) and granulated hardwood (example 3) which are in each case obtainable from ASK, Hilden, Germany, were used. The additives were in each case tested as supplied (example (a)) and modified with 2.5% of Q-Cel® (example (b)).

Iron (GG 25) was used as casting metal. The casting temperature was in the range from 1420 to 1430° C. The casting time was 10 seconds.

The experimental data are summarized in table 1.

TABLE 1
Casting experiments using uncoated moldings

| Experiment | Comp. | 1A | 1B | 2A | 2B | 3A | 3B |
|---|---|---|---|---|---|---|---|
| Additive | — | Starch | Q-CEL/starch | Mica | Q-CEL/ | Granulated | Q-Cel/ |
| | | | | | mica | hardwood | granulated |
| | | | | | | | hardwood |
| Amount | — | 1.5% | 1.5% | 1.5% | 1.5% | 2% | 1% |
| Part 1: | 0.8% | 0.9% | 0.9% | 0.9% | 0.9% | 0.8% | 0.8% |
| Part 2: | 0.8% | 0.9% | 0.9% | 0.9% | 0.9 | 0.8% | 0.8% |
| Composition [%] | | | | | | | |
| Additive | | 100.0 | 97.5 | 100.0 | 97.5 | 100.0 | 97.5 |
| QCEL | | | 2.5 | | 2.5 | | 2.0 |
| Product features | | | | | | | |
| Bulk density | | 0.58-0.68 | 0.58-0.64 | 0.36-0.42 | 0.39-0.4 | 0.25-0.30 | 0.25-0.30 |
| Evaluation of casting | | | | | | | |
| Casting metal | GG 25 | CG 25 | GG 25 | GG 25 | GG 25 | GG 25 | GG 25 |
| Casting temperature | 1420° C. | 1420° C. | 1429° C. | 1420° C. | 1420° C. | 1429° C. | 1420° C. |
| Casting time | 10″ | 10″ | 10″ | 10″ | 10″ | 10″ | 10″ |
| Prominence of flash | very great | none | none | none | none | none | none |
| Penetration | low | intermediate | none | none | none | great | none |
| Erosion | | | | great | none | | |
| Miscellaneous | | | | | | | |

The test specimens obtained are reproduced photographically in FIG. 1. FIG. 1 shows two photographs of each test specimen taken using different illumination directions.

In the comparative example, i.e. without addition of an additive, only a low penetration was observed, as can be seen from the smooth surface of the test specimen. However, very pronounced flash formation occurred, as can be seen as significant raised lamellae on the surface of the test specimen in the photograph.

In example 1A, in which pure starch has been added as additive, no flash formation was observed. No raised lamellae can be seen on the surface of the test specimen in the photograph. The surface is uniformly curved. However, an intermediate degree of penetration of the iron into the casting mold occurs. This can be seen on the photograph from the rough surface of the test specimen which causes strong scattering of the incident light.

In example 1B, in which Q-Cel® was added as additive in a proportion of 2.5% by weight of the starch, no flash formation is observed. The surface is uniformly curved and shows no sharp-edged elevations. The test specimen displays a clean cast surface, which can be seen from the uniform, slightly mirror-like reflection of the light.

When mica is used as additive as in example 2A, no flash formation is observed but the test specimen displays strong erosion, which can be seen from the irregular shape of the test specimen.

When Q-Cel® hollow microspheres are added as further additive in addition to the mica as in example 2B, no flash formation is observed. A clean cast surface of the test specimen is observed. This can be seen in the photograph from the slightly reflective surface of the test specimen.

In example 3A, a granulated hardwood is used as additive. No flash formation is observed. However, as the photograph shows, very pronounced penetration of the liquid iron into the casting mold occurs. The surface of the test specimen is very rough and strongly scatters the incident light.

When Q-Cel-hollow microspheres are added as further additive to the granulated hardwood as in example 3B, no flash formation is observed. The surface of the test specimen is smooth, as can be seen from the reflection of the incident light.

In the case of all types of additive, a significant improvement in the cast surface was achieved by means of a very small addition of Q-Cel hollow microspheres. It is even sometimes possible to dispense with application of a wash in the case of thin-walled castings or to use thinly coated cores.

### EXAMPLES 4 AND 5

### Use of Hollow Microspheres in Washes

Q-Cel® hollow microspheres were added to a wash which already had a good action against the formation of flash. To test the wash, dome cores comprising sand, additive and cold box resin were produced as described below. The commercial Kerntop® WV 021010B from Ashland-Südchemie-Kernfest GmbH was used as wash. The pure wash was used in example 4, while 0.3% by weight of Q-Cel® hollow microspheres were added to the wash in example 5. The viscosity of the washes was set so that the same layer thicknesses are achieved by dipping. The experimental conditions and the results are summarized in table 2.

TABLE 2
Casting experiments using coated moldings

| | Example | | | |
|---|---|---|---|---|
| | 4 | | 5 | |
| Additive | | | | |
| Sand | H 32 | | H 32 | |
| Part 1 (IC 366) | 0.8% | | 0.9% | |
| Part 2 (IC 666) | 0.8% | | 0.9% | |
| Composition [%] | | | | |
| Kerntop WV 021010 B | 100.0 | | 99.7 | |
| Q-CEL | — | | 0.3 | |
| Product features | | | | |
| Brookfield viscosity, | 320 | mPas | 320 | mPas |
| Spindle 4, 20 rpm | | | | |
| Running-out time DIN 4 mm | 12.8 | s | 12.8 | s |
| Wet layer thickness | 250 | μm | 250 | μm |

| | | |
|---|---|---|
| (matted off) | | |
| Casting metal | SiMo KKK 6586 | SiMo KKK 6586 |
| Casting temperature | 1478° C. | 1478° C. |
| Casting time | approx. 10 s | approx. 10 s |
| Occurrence of flash | very great | none |
| Penetration | low | none |
| Erosion | none | none |

The test specimens obtained are reproduced photographically in FIG. 2. In example 4, a slight tendency for flash to be formed is observed. The surface of the test specimen is slightly matt. Slight penetration of the liquid iron into the molding occurs. When small amounts of hollow borosilicate glass microspheres are added, formation of flash is no longer observed. The casting surface is smooth, as can be seen from the reflection of light on the surface of the test specimen.

1. A molding composition for producing casting molds for the foundry industry, comprising:
a refractory mold material;
a binder for curing the molding composition; and
a borosilicate glass in the form of a granulate or a powder.

2. The molding composition as claimed in claim 1, characterized in that the borosilicate glass is present in a proportion of at least 0.001% by weight, based on the refractory mold material, in the molding composition.

3. The molding composition as claimed in claim 1, characterized in that the borosilicate glass is present in the form of hollow microspheres in the molding composition.

4. The molding composition as claimed in claim 3, characterized in that the hollow microspheres have an average diameter of less than 200 μm.

5. The molding composition as claimed in claim 3, characterized in that the hollow microspheres have a wall thickness of 5-30% of their external diameter.

6. The molding composition as claimed in claim 3, characterized in that the hollow microspheres have a bulk density of less than 1.2 g/ml.

7. The molding composition as claimed in claim 1, characterized in that the borosilicate glass has a proportion of boron, calculated as B₂O₃, of more than 3% by weight.

8. The molding composition as claimed in claim 1, characterized in that the borosilicate glass has a softening point of less than 1500° C.

9. The molding composition as claimed in claim 1, characterized in that the binder is selected from the group consisting of cold box binders, hot box binders, silicate binders, in particular water glass, self-curing binders and mixtures thereof.

10. The molding composition as claimed in claim 9, characterized in that the cold box binder is selected from the group consisting of phenol-urethane resins, epoxy-acrylic resins, alkaline phenolic resins, water glass, self-curing resins and mixtures thereof.

11. The molding composition as claimed in claim 1, characterized in that the molding composition further comprises at least one further additive for reducing flash formation in addition to the borosilicate glass.

12. The molding composition as claimed in claim 11, characterized in that the at least one further additive is selected from the group consisting of organic combustible compounds, mica, iron oxide, and mixtures thereof.

13. The molding composition as claimed in claim 1, characterized in that the molding composition further comprises at least one organic or inorganic acid and/or acid source.

14. The molding composition as claimed in claim 1, wherein the molding composition is in the form of a wash.

15. A process for producing a molding for the foundry industry, comprising
preparing a model which corresponds to at least a section of a casting;
introducing a molding composition comprising a refractory mold material, a binder, and a borosilicate glass in the form of a granulate or a powder into the model;
curing the molding composition to form a molding; and
removing the molding from the model.

16. (canceled)

17. (canceled)

18. A molding for the foundry industry made of a refractory mold material, comprising borosilicate glass, in the form of a granulate or a powder.

19. The molding as claimed in claim 18, characterized in that the borosilicate glass is present in the form of hollow microspheres.

20. (canceled)

21. A process for casting a metal casting comprising introducing molten metal into a mold made from the molding composition of claim 1.

22. The molding of claim 18 wherein the sections of the molding which come into contact with liquid metal during a casting process contain borosilicate glass in the form of a granulate or a powder.

23. A process for producing a molding for the foundry industry, comprising:
preparing a model which corresponds to at least a section of a casting;
introducing a molding mix comprising a refractory mold material, and a binder into the model;
curing the molding composition to form a molding;
removing the molding from the model; and
applying a molding composition comprising a refractory mold material, a binder, and a borosilicate glass in the form of a granulate or a powder to at least the surfaces of the molding which come into contact with liquid metal during a casting process.

24. The process of claim 23, wherein the molding mix further comprises a borosilicate glass in the form of a granulate or a powder.
